(19) United States
(12) Patent Application Publication
(10) Pub. No.: US 2025/0187027 A1
(43) Pub. Date: Jun. 12, 2025

(54) PNEUMATIC SPRAYER

(71) Applicant: ZHEJIANG PRULDE ELECTRIC APPLIANCE CO., LTD., Zhejiang (CN)

(72) Inventor: Chenghao YANG, Jinhua (CN)

(73) Assignee: ZHEJIANG PRULDE ELECTRIC APPLIANCE CO., LTD., Zhejiang (CN)

(21) Appl. No.: 18/972,096

(22) Filed: Dec. 6, 2024

(30) Foreign Application Priority Data
Dec. 8, 2023 (CN) 2023233630463

(51) Int. Cl. B05B 7/24

(52) U.S. Cl. CPC B05B 7/2429; B05B 7/2416

(57) ABSTRACT

A pneumatic sprayer, including a gun body including a valve core and an air passage, container, nozzle assembly, and trigger, the nozzle assembly including a nozzle cap provided with a liquid outlet hole, an air cap disposed at a front side of the nozzle cap, and a lock ring securing the caps to a front end of the gun body, the air cap being provided with an air outlet hole communicating with the air passage; a snap-fit structure is arranged between the nozzle cap and air cap, and the lock ring locks the caps which have been snapped together. By first snapping the nozzle cap and the air cap together via a snap-fit structure to form a module, fitting between the nozzle assembly and the gun body may be eased, which facilitates mounting the nozzle assembly to the front end of the gun body and improves user experience.

### FIELD

The subject matter described herein relates to a power tool, and more particularly relates to a pneumatic sprayer.

### BACKGROUND

A pneumatic sprayer is a common paint sprayer, mainly comprising a spray gun, a container configured to hold a paint, and an air processor configured to produce compressed air, the paint being pressurized by the compressed air so that the paint is sprayed out of a nozzle at a front end of the spray gun onto a to-be-painted object. An existing nozzle usually comprises a nozzle cap having a liquid outlet hole, an air cap disposed at a front side of the nozzle cap, and a lock ring configured to lock the nozzle cap and the air cap to the front end of the spray gun. Since the nozzle cap and the air cap are separate parts without a fitting structure, they are easily misaligned during a process of locking, via the lock ring, the nozzle cap and the air cap to the front end of the spray gun; this difficulty in lock-fitting deteriorates user experience.

### SUMMARY

To overcome the above and other drawbacks and disadvantages in conventional technologies, a pneumatic sprayer is provided herein, which, by applying a snap-fit structure to first snap a nozzle cap and an air cap together into a module, may ease fitting between a nozzle assembly and a gun body and facilitate a user to mount the nozzle assembly to a front end of the gun body, whereby user experience is enhanced.

A pneumatic sprayer described herein comprises: a gun body comprising a valve core and an air passage, a container attached to the gun body, a nozzle assembly disposed at a front end of the gun body, and a trigger acting on the valve core, the nozzle assembly comprising a nozzle cap provided with a liquid outlet hole, an air cap disposed at a front side of the nozzle cap, and a lock ring securing the nozzle cap and the air cap to the front end of the gun body, the air cap being provided with an air outlet hole communicating with the air passage, characterized in that a snap-fit structure is arranged between the nozzle cap and the air cap, and the lock ring locks the nozzle cap and the air cap which have been snapped together to the front end of the gun body.

In some implementations, an annular protrusion extending axially is arranged at an outer peripheral edge of the air cap, and a front raised edge is provided for the nozzle cap, the front raised edge extending forwardly from an outer peripheral edge of the nozzle cap, the snap-fit structure being disposed between the annular protrusion and the front raised edge.

In some implementations, the snap-fit structure comprises a first snap-fit part arranged on an outer wall of the annular protrusion and a second snap-fit part arranged on an inner wall of the front raised edge, the second snap-fit part and the first snap-fit part being snapped in a front-rear direction so that the air cap and the nozzle cap are limited relative to each other.

In some implementations, the first snap-fit part is a convex rib or a protrusion; and/or, the second snap-fit part is a convex rib or a protrusion.

In some implementations, a limiting rib protruding forward is arranged at a front side of the front raised edge and/or at a front side of the gun body, and a limiting block is arranged on an outer wall of the annular protrusion, the limiting block abutting against an end portion of the limiting rib so that the air cap is circumferentially limited.

In some implementations, the nozzle cap is provided with a communication hole configured to communicate between the air passage and the air outlet hole, and the nozzle assembly further comprises an adjustment cap disposed between the front end of the gun body and the nozzle cap, the adjustment cap being provided with a shifting block projecting out of the gun body and an adjustment hole corresponding to the communication hole, the adjustment cap being rotated to adjust a ventilation area between the air passage and the communication hole.

In some implementations, a slide groove in which the shifting block moves and a groove opening communicating with the slide groove are provided at the front end of the gun body, the slide groove extending along a circumferential direction of the gun body, the groove opening extending forward from one end of the slide groove, the nozzle cap being provided with a limiting tab that extends rearward and fits the groove opening; and/or, the nozzle cap is provided with a rear raised edge extending rearward from an outer peripheral edge of the nozzle cap, a stepped surface being provided on an outer peripheral wall of the adjustment cap, the rear raised edge abutting against the stepped surface.

In some implementations, the lock ring is tightly locked to the front end of the gun body in a threaded-fitting manner, a circle of limiting edge protruding inwardly and fitted with an outer peripheral edge of the air cap is provided at a front end of the lock ring, and a stud abutting against a front side of the limiting edge is arranged on an outer wall of the air cap.

In some implementations, a ventilation structure configured to communicate between the air passage and an internal cavity of the container is arranged between the gun body and the container; and/or, a pressure relief hole and a pressure relief valve operable to open and close the pressure relief hole are provided on the container.

In some implementations, the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body. With the technical solutions noted supra, the disclosure offers the following benefits:

1. The pneumatic sprayer described herein arranges a snap-fit structure between the nozzle cap and the air cap, so that to mount the nozzle assembly to the front end of the gun body, the nozzle cap and the air cap may be first snapped together via the snap-fit structure, and then the lock ring is applied to lock the nozzle cap and the air cap which have been snapped together to the front end of the gun body. Since the nozzle cap and the air cap have been snapped together in advance to form a module, the nozzle cap and the air cap do not misalign from each other during the process of being locked by the lock ring to the front end of the gun body, which may ease fitting between the nozzle assembly and the gun body, facilitating a user to mount the nozzle assembly to the front end of the gun body, whereby user experience is enhanced.

2. The annular protrusion is arranged at the outer peripheral edge of the air cap, and the front raised edge is provided at the outer edge of the nozzle cap, and the snap-fit structure is disposed between the annular protrusion and the front raised edge. Specifically, the first snap-fit part is arranged on the outer wall of the annular protrusion, the second snap-fit part is arranged on the inner wall of the front raised edge, and the first snap-fit part and the second snap-fit part may be specifically a convex rib or a protrusion. By reasonably arranging the snap-fit structure, the nozzle cap and the air cap may be subjected to axial limitation and radial limitation relative to each other, preventing the nozzle cap and the air cap which have been snapped together from misaligning during the process of being locked by the lock ring to the front end of the gun body.

3. By arranging the forward-protruding limiting rib at the front side of the raised edge and/or at the front side of the gun body, arranging the limiting block on the outer wall of the annular protrusion, and disposing the limiting block to abut against an end portion of the limiting rib, the air cap is limited circumferentially, which ensures structural stability when the air cap is locked to the front end of the gun body.

4. The nozzle assembly is provided with an adjustment cap; by rotating the adjustment cap, the adjustment hole rotates relative to the communication hole to thereby adjust the open degree of the communication hole, whereby the ventilation area between the air passage and the communication hole is adjusted, the intensity of the air flow sprayed out from the air outlet holes is further adjusted, and finally an atomized spray profile of the paint sprayed out of the liquid outlet holes is adjusted; this facilitates a user to adjust the paint atomized spray effect by the adjustment cap dependent on different spray requirements.

5. By arranging the slide groove and the groove opening at the front end of the gun body, the shifting block to be mounted may access the slide groove from the groove opening, which allows for smooth mounting of the adjustment cap into the front end of the gun body; the slide groove may also be configured to limit a rotary extent of the shifting block, thereby limiting the rotating angle of the adjustment cap.

By arranging the rearward extending limiting tab for the air cap, fitting between the limiting tab and the groove opening allows for the air cap and the nozzle cap to be circumferentially limited, which may enhance structural stability between the air cap and the nozzle cap and prevent the air cap and the nozzle cap from rotating along with the rotating adjustment cap.

By arranging the rear raised edge extending rearward from the outer edge for the nozzle cap and disposing the rear raised edge to abut against the stepped surface on the outer peripheral wall of the adjustment cap, the air cap and the nozzle cap are axially positioned, whereby structural stability between the air cap and the nozzle cap can be enhanced.

6. The threaded-fitting manner of tightly locking the lock ring to the front end of the gun body offers a simpler fit structure and a higher locking strength between the nozzle assembly and the gun body; the lock ring may stably lock the air cap and the nozzle cap to the front end of the gun body. By arranging a limiting edge at the front end of the lock ring, the limiting edge being fitted with an outer peripheral edge of the air cap, and arranging, on the outer wall of the air cap, a stud abutting against the front side of the limiting edge, axial stability between the air cap and the nozzle cap is enhanced, preventing the nozzle cap and the air cap from axial play during operating.

7. Since the air pressure in the container is still high when a spraying operation just ends, a pressure relief hole and a pressure relief valve operable to open and close the pressure relief hole are provided on the container, so that upon end of the spraying operation, the pressure relief valve may open the pressure relief hole to release the pressure inside the container, which prevents the paint in the container from flowing towards the liquid outlet hole and leaking outward from the liquid outlet hole under the air pressure.

### BRIEF DESCRIPTION OF THE DRAWINGS

FIG. 1 is an overall structure of a pneumatic sprayer with a stationary body according to a first implementation;

FIG. 2 is an internal structural diagram of the stationary body in the pneumatic sprayer according to the first implementation;

FIG. 3 is a partial structural exploded view of the pneumatic sprayer according to the first implementation;

FIG. 4 is a disassembled diagram of the pneumatic sprayer with a handheld body according to the first implementation;

FIG. 5 is an internal structural view of the handheld body of the pneumatic sprayer

according to the first implementation;

FIG. 6 is a sectional view of a partial structure of the pneumatic sprayer in an axial direction of a gun body according to the first implementation;

FIG. 7 is a sectional view of a nozzle assembly and a local gun body in the pneumatic sprayer according to the first implementation;

FIG. 8 is an exploded view of the nozzle assembly in the pneumatic sprayer according to the first implementation;

FIG. 9 is a structural view of a nozzle cap in the pneumatic sprayer according to the first implementation;

FIG. 10 is an exploded view of part of the members of the nozzle assembly and a local gun body in the pneumatic sprayer according to the first implementation;

FIG. 11 is a structural view of part of the members of the nozzle assembly mounted to a front end of the gun body in the pneumatic sprayer according to the first implementation;

FIG. 12 is a sectional view of partial structure of the pneumatic sprayer perpendicular to the axial direction of the gun body according to the first implementation.

In the drawings: 10—pneumatic sprayer;
100—gun body; 110—valve core; 111—core shaft; 112—bar linkage; 113—first spring; 120—air passage; 130—housing; 131—barrel portion; 1311—second limiting rib; 132—guiding portion; 133—connecting portion; 134—valve sleeve; 135—valve chamber; 136—guiding tube; 137—guiding passage; 140—liquid intake tube; 151—slide groove; 152—groove opening; 160—sealing pad;
200—container; 210—pressure relief hole;
300—nozzle assembly; 310—nozzle cap; 311—liquid outlet hole; 312—conical shell; 313—front raised edge; 314—second snap-fit part; 315—first limiting rib; 316—communication hole; 317—limiting tab; 318—rear raised edge; 319—arc-shaped hole; 320—air cap; 321—annular protrusion; 322—first snap-fit part; 323—limiting block; 324—hollow boss; 325—air outlet hole; 325a—first air outlet hole; 325b—second air outlet hole; 325c—third air outlet hole; 326—stud; 330—lock ring; 331—limiting edge; 340—adjustment cap; 341—shifting block; 342—adjustment hole; 343—stepped surface; 344—central hole; 30A—snap-fit structure;
400—trigger; 410—adjustment rotary knob; 420—second spring;
510—stationary body; 511—first housing; 512—first air compressor; 520—handheld body; 521—second housing; 5211—grip; 522—second air compressor; 530—air tube; 540—handle piece; 541—cylindrical shell; 542—handle;
600—ventilation structure; 610—ventilation fitting; 620—unidirectional air intake valve; 621—inner valve shell; 622—outer valve shell; 623—elastic valve plate; 624—upper valve hole; 625—lower valve hole; 630—hose;
700—pressure relief valve; 710—plug head; 720—valve bonnet; 730—third spring; 740—seal ring.

### DETAILED DESCRIPTION OF EMBODIMENTS

Hereinafter, the technical solution of the disclosure will be described in detail through specific implementations with reference to the accompanying drawings. It needs to be understood that the orientational or positional relationships indicated by the terms “upper,” “lower,” “left,” “right,” “transverse,” “longitudinal,” “inner,” “outer,” “perpendicular,” “horizontal,” “top,” and “bottom” are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

### First Implementation

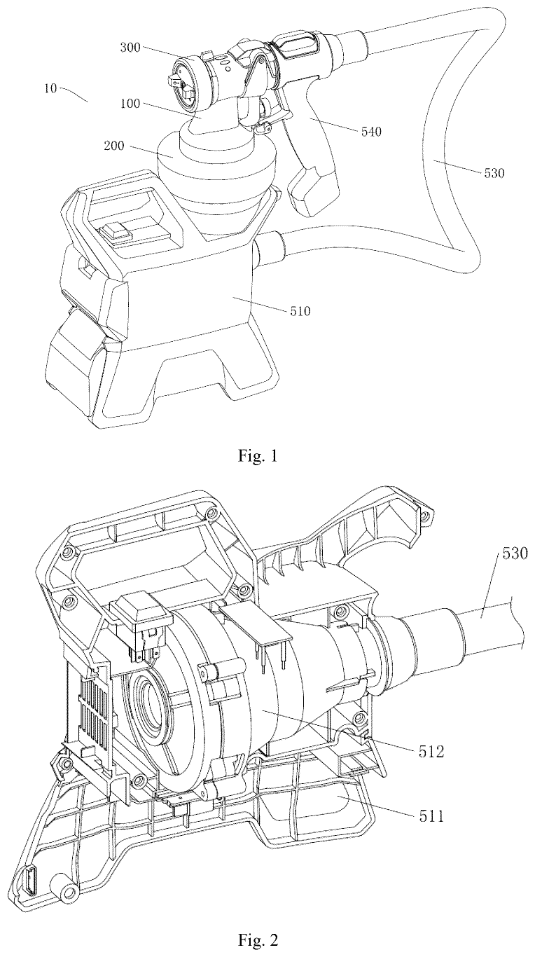

Referring to FIGS. 1 to 12, a pneumatic sprayer 10 according to a first implementation of the disclosure comprises a gun body 100 comprising a valve core 110 and an air passage 120, a container 120 attached to the gun body 100, a nozzle assembly 300 disposed at a front end of the gun body 100, and a trigger 400 acting on the valve core 110; the nozzle assembly 300 comprises a nozzle cap 310 provided with a liquid outlet hole 311, an air cap 320 disposed at a front side of the nozzle cap 310, and a lock ring 330 securing the nozzle cap 310 and the air cap 320 to the front end of the gun body 100; the air cap 320 is provided with an air outlet hole 325 communicating with the air passage 120. A snap-fit structure 30A is arranged between the nozzle cap 310 and the air cap 320; the lock ring 330 locks the snap-fitted nozzle cap 310 and air cap 320 to the front end of the gun body 100.

Since the nozzle cap 310 and the air cap 320 may be first snapped together to form a module, the nozzle cap 310 and the air cap 320 do not misalign from each other during the process of being locked by the lock ring 330 to the front end of the gun body 100, which may ease fitting between the nozzle assembly 300 and the gun body 100, facilitating a user to mount the nozzle assembly 300 to the front end of the gun body 100, whereby user experience is enhanced.

Referring to FIG. 12, in this implementation, the gun body 100 comprises a housing 130, the housing 130 comprising a barrel portion 131, a guiding portion 132 extending downward from the barrel portion 131, and a connecting portion 133 extending downward from the guiding portion 132, the barrel portion 131, the guiding portion 132, and the connecting portion 133 being arranged axially along a front-rear direction, in the barrel portion 131 being provided a valve sleeve 134 that is hollow inside, a valve chamber 135 being defined by an internal cavity of the valve sleeve 134, the air passage 120 being arranged between the valve sleeve 134 and the barrel portion 131. A guiding tube 136 that is hollow inside is arranged in the guiding portion 132, a guiding passage 137 being defined by an internal cavity of the guiding tube 136, a lower end of the guiding tube 136 being connected to a liquid intake tube 140 that projects into the container 200. An upper end of the guiding passage 137 communicates with the valve chamber 135, and a lower end of the guiding passage 137 communicates with an internal cavity of the container 200 via the liquid intake tube 140.

Referring to FIG. 6, the valve core 110 is arranged in the valve sleeve 134 in a front-rear movable manner. Exemplarily, the valve core 110 comprises a core shaft 111, a bar linkage 112 connected to a rear end of the core shaft 112, and a first spring 113 disposed at a rear end of the bar linkage 112; a rear end of the core shaft 111 being securely insertion-fitted with a front end of the bar linkage 112, the first spring 113 being sleeved at a rear end of the bar linkage 112 and disposed in a compressed state, a front end of the first spring 113 abutting against the bar linkage 112, a rear end of the first spring 113 being inserted in a slot of the barrel portion 131 to abut against an inner wall of the slot so as to hold position. An upper end of the trigger 400 is hinged to the barrel portion 131, the trigger 400 partially passing through a hole on the bar linkage 112; an adjustment rotary knob 410 configured to adjust a rearward swing amplitude of the trigger 400 is provided at a rear side of a lower portion of the trigger 400, and a second spring 420 is arranged between the adjustment rotary knob 410 and the trigger 400, one end of the second spring 420 abutting against the trigger 400, an opposite end thereof abutting against the adjustment rotary knob 410.

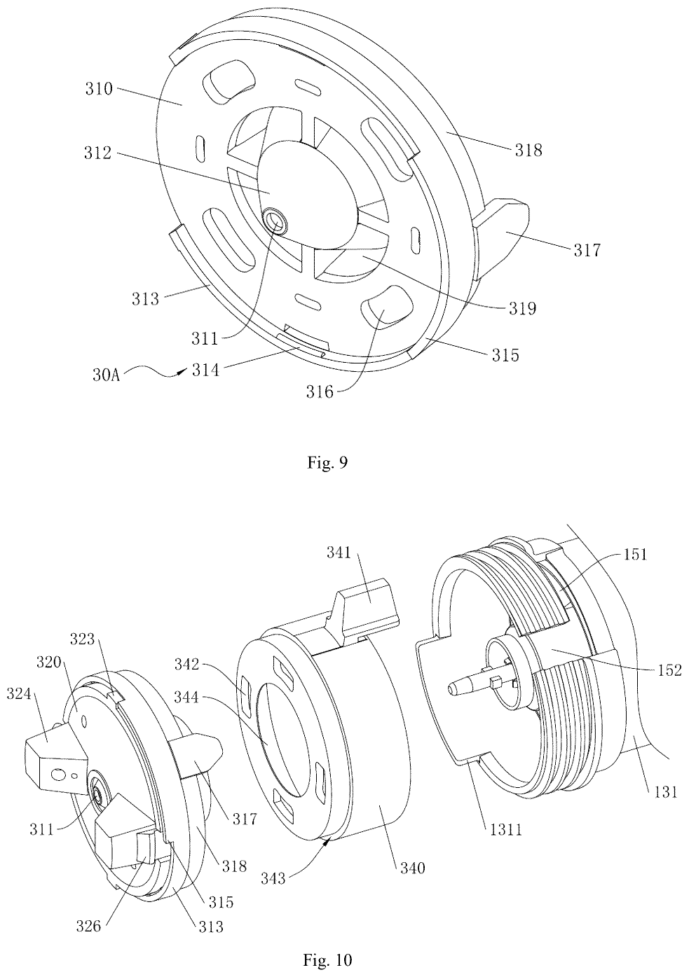

Referring to FIG. 9, a conical shell 312 is arranged at a center of the nozzle cap 310, a rear end of the conical shell 312 being hermetically fitted with a front end of the valve sleeve 134; the liquid outlet hole 311 is provided at a front end of the conical shell 312, a front end of the core shaft 111 being fitted with the liquid outlet hole 311 to open and close the liquid outlet hole 311. When the trigger 400 swings rearward so that the valve core 110 is driven to overcome a pretensioned force of the first spring 113 to move rearward, the first spring 113 is stressed and compressed, whereby the front end of the core shaft 111 migrates from the conical shell 312 to open the liquid outlet hole 311. When the trigger 400 is released, the first spring 113 recovered from deformation drives the valve core 110 to swing forward, whereby the front end of the core shaft 111 abuts against the conical shell 312 to close the liquid outlet hole 311.

Referring to FIGS. 8 and 9, an annular protrusion 321 extending axially is provided at an outer peripheral edge of the air cap 320, and a front raised edge 313 is provided for the nozzle cap 310, the front raised edge 313 extending forwardly from an outer peripheral edge of the nozzle cap 310, the snap-fit structure 30A being arranged between the annular protrusion 321 and the front raised edge 313. The snap-fit structure comprises a first snap-fit part 322 disposed on an outer wall of the annular protrusion 321 and a second snap-fit part 314 disposed on an inner wall of the front raised edge 313, the second snap-fit part 314 and the first snap-fit part 322 being snapped in a front-rear direction so that the air cap 320 and the nozzle cap 310 are limited relative to each other. Exemplarily, the first snap-fit part 322 is an arc-shaped convex rib disposed on the outer wall of the annular protrusion 321, and the second snap-fit part 314 is an arc-shaped protrusion disposed on the inner wall of the front raised edge 313; when the air cap 320 and the nozzle cap 310 are assembled together, the annular protrusion 321 is located at an inner periphery of the front raised edge 313 and the second snap-fit part 314 abuts against the first snap-fit part 322 in a front-rear direction; the inner-outer abutment between the annular protrusion 321 and the front raised edge 313 allows for the air cap 320 and the nozzle cap 310 to be radially limited relative to each other; the front-rear abutment between the second snap-fit part 314 and the first snap-fit part 322 allows for the air cap 320 and the nozzle cap 310 to be axially limited relative to each other; as such, misalignment between the nozzle cap 310 and the air cap 320 snapped together is prevented during the process of being locked by the lock ring 330 to the front end of the gun body 100. It may be understood that, the first snap-fit part 322 may also be formed of an arc-shaped protrusion or a block-shaped protrusion, while the second snap-fit part 314 may be formed of an arc-shaped convex rib or a block-shaped protrusion.

Referring to FIG. 10, a first limiting rib 315 protruding forward is arranged at a front side of the front raised edge 313, a second limiting rib 1311 protruding forward is arranged at a front end of the barrel portion 131, and two limiting blocks 323 distributed circumferentially at an interval are provided on the outer wall of the annular protrusion 321, one limiting block 323 thereof abutting against an arc-directional end portion of the first limiting rib 315, the other limiting block 323 abutting against an arc-directional end portion of the second limiting rib 1311; the abutment fitting between the limiting blocks 323 and the two limiting ribs allows for circumferential limitation to the air cap 320, which ensures structural stability of the air cap 320. It may be understood that, the second limiting rib 1311 may also be formed by protruding forward from the front side of the front raised edge 313, or the first limiting rib 315 may be formed by protruding forward from the front end of the barrel portion 313.

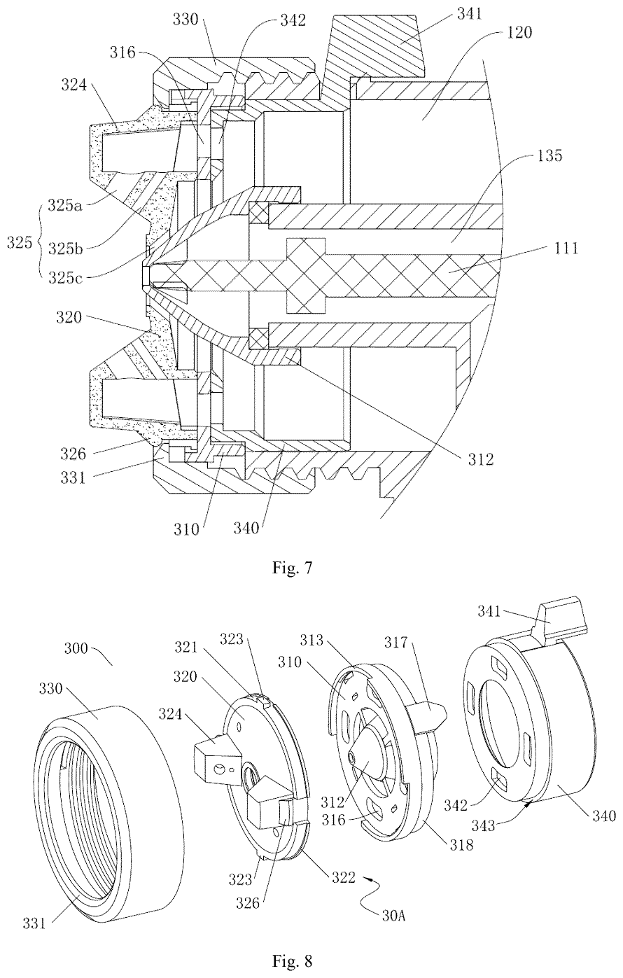

Referring to FIG. 7, in this implementation, the air cap 320 is provided with two hollow bosses 324 that are symmetrically distributed and protrude forward, each hollow boss 324 being provided with a first air outlet hole 325a and a second outlet hole 325b that are distributed at an interval on a side wall facing the liquid outlet hole 311, the first air outlet hole 325a and the second air outlet hole 325b communicating with an internal cavity of the hollow boss 324. A third air outlet hole 325c is provided at the center of the air cap 320, an internal diameter of the third air outlet hole 325c being greater than an outer diameter of the conical shell 312, a front end of the conical shell 312 being inserted in the third air outlet hole 325c so that a circle of air outlet gap is formed on an outer periphery of the conical shell 312.

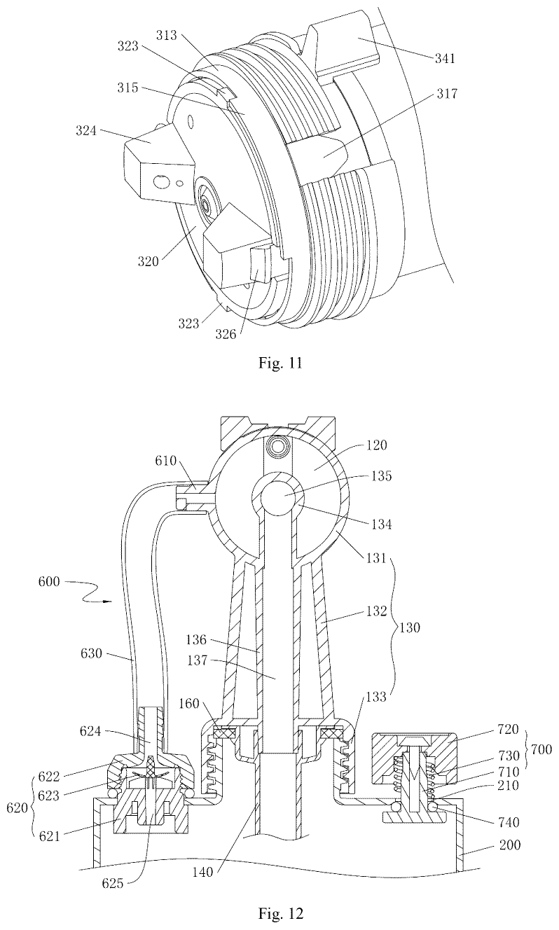

Referring to FIG. 9, the nozzle cap 310 is provided with communication holes 316 configured to communicate between the air passage 120 and the air outlet hole 325 and arc-shaped holes 319, the arc-shaped holes 319 being distributed at intervals at the outer periphery of the conical shell 312, the communication holes 316 being distributed at intervals at outer peripheries of the arc-shaped holes 319. To adjust a spray profile of an atomized paint, the nozzle assembly 300 further comprises an adjustment cap 340 arranged between the front end of the gun body 100 and the nozzle cap 310, the adjustment cap 340 being provided with a shifting block 341 projecting out of the gun body 100; adjustment holes 342 corresponding to the communication holes 316 and a central hole 344 with an internal diameter being greater than the outer diameter of the conical shell 312 are arranged on a front side wall of the adjustment cap 340, the adjustment holes 342 being distributed in a manner of one-to-one corresponding to the communication holes 316; the adjustment cap 340 is rotated to adjust a ventilation area between the air passage 120 and the communication holes 316, so that an intensity of air flows sprayed out of the first air outlet hole 325a and the second air outlet hole 325b is adjusted, and finally an atomized spray profile of the paint sprayed out of the liquid outlet hole 311 is adjusted. Referring to FIGS. 10 and 11, the adjustment cap 340 is disposed in the front end of the barrel portion 131, and a slide groove 151 in which the shifting block 341 moves and a groove opening 152 communicating with the slide groove 151 are provided at the front end of the barrel portion 131, the slide groove 151 extending along the circumferential direction of the gun body 100 and being formed into an arc shape, the groove opening 152 extending forward from one end of the slide groove 151, so that the shifting block 341 may be mounted in a manner of accessing the inside of the slide groove 151 from the groove opening 152, which facilitates mounting of the adjustment cap 340 into the front end of the barrel portion 131. The slide groove 151 may also be configured to limit a rotatable extent of the shifting block 341, whereby the rotatable angle of the adjustment cap 340 is limited.

Referring to FIGS. 10 and 11, the nozzle cap 310 is provided with a limiting tab 317 extending rearward and fitted with the groove opening 152; fitting between the limiting tab 317 and the groove opening 152 allows for the air cap 320 and the nozzle cap 310 to be circumferentially limited, which may improve structural stability between the air cap 320 and the nozzle cap 310 and prevent the air cap 320 and the nozzle cap 310 from rotating along with the rotating adjustment cap 340. Referring to FIG. 9, the nozzle cap 310 is provided with a rear raised edge 318, the rear raised edge 318 extending rearward from the outer peripheral edge of the nozzle cap 310; the adjustment cap 340 is formed to having an increasing outer diameter from front to rear, a stepped surface 343 being formed on the outer peripheral wall of the adjustment cap 340, the rear raised edge 318 abutting against the stepped surface 343 so that the air cap 320 and the nozzle cap 310 may be axially limited.

Referring to FIG. 7, the lock ring 330 is tightly locked to the front end of the barrel portion 131 in a threaded-fitting manner, a circle of limiting edge 331 protruding inwardly and fitted with the outer peripheral edge of the air cap 320 is arranged at a front end of the lock ring 330, and a stud 326 protruding outwardly is provided for the air cap 320 on an outer wall of the hollow boss 324, the stud 326 abutting against a front side of the limiting edge 331; in this way, the axial stability between the air cap 320 and the nozzle cap 310 is improved, which prevents axial play of the air cap 320 and the nozzle cap 310 during operating.

To mount the nozzle assembly 300 to the front end of the gun body 100, the adjustment cap 340 is first installed in the front end of the barrel portion 131; axial positioning of the adjustment cap 340 may be realized by fitting between the shifting block 341 and the slide groove 151, or, a bump abutting against the adjustment cap 340 to axially position the adjustment cap 340 may be arranged on an inner wall of the barrel portion 131 or on an outer wall of the valve sleeve 134. The nozzle cap 310 and the air cap 320 are assembled together via the snap-fit structure; by inserting the annular protrusion 321 in the front raised edge 313 and disposing the second snap-fit part 314 and the first snap-fit part 322 to abut in a front-rear direction, the air cap 320 is substantially fitted snug with the nozzle cap 310. Then, the assembled nozzle cap 310 and air cap 320 are mounted to the front end of the barrel portion 131; by inserting the limiting tab 317 in the groove opening 152 and sleeving the rear raised edge 318 outside the front end of the adjustment cap 340 to abut against the stepped surface 343, the nozzle cap 310 is substantially fitted snug with the front side wall of the adjustment cap 340; by disposing the two limiting blocks 323 to respectively abut against the end portions of the first limiting rib 315 and the second limiting rib 1311, the nozzle cap 310 and the air cap 320 are circumferentially limited. Next, the lock ring 330 is tightly locked to the front end of the barrel portion 131, where the limiting edge 331 of the lock ring 330 abuts against the outer peripheral edge of the air cap 320, and the stud 326 projects out of the lock ring 330 to abut against the front side of the limiting edge 331.

Referring to FIG. 12, a ventilation structure 600 configured to communicate between the air passage 120 and the internal cavity of the container 200 is arranged between the gun body 100 and the container 200; the ventilation structure 600 comprises a ventilation fitting 610 arranged on the barrel portion 131, a unidirectional air intake valve 620 disposed at a top side of the container 200, and a hose 630 configured to connect the ventilation fitting 610 and the unidirectional air intake valve 630; the unidirectional air intake valve 620 comprises an inner valve shell 621, an outer valve shell 622, and an elastic valve plate 623; an upper valve hole 624 is arranged on the outer valve shell 622, and a lower valve hole 625 is arranged on the inner valve shell 621; the inner valve shell 621 and the outer valve shell 622 are secured together in a threaded-fitting manner; the elastic valve plate 623 is disposed between the inner valve shell 621 and the outer valve shell 622 and configured to communicate or cut off communication between the upper valve hole 624 and the lower valve hole 625; the inner valve shell 621 is secured to the top side of the container 200, and the outer valve shell 622 is located outside the container 200. One end of the hose 630 is coupled to the ventilation fitting 610, and an opposite end thereof is coupled to the outer valve shell 622. The pressurized air in the air passage 120 may flow towards the unidirectional air intake valve 620 through the ventilation fitting 610 and the hose 630; when the air pressure in the upper valve hole 624 reaches a preset value, the elastic valve plate 623 is deformed to communicate between the upper valve hole 624 and the lower valve hole 625, so that the pressurized air may flow through the unidirectional air intake valve 620 into the container 200 to increase the air pressure inside the container 200, whereby the paint in the container 200 flows upward through the liquid intake tube 140 and the guiding tube 136 into the valve chamber 135 under the action of the pressurized air to realize paint feeding. When the air pressure in the upper valve hole 624 is lower than the preset value, the elastic valve plate 623 recovers from deformation to cut off communication between the upper valve hole 624 and the lower valve hole 625.

Referring to FIG. 12, a pressure relief hole 210 and a pressure relief valve 700 operable to open and close the pressure relief hole 210 are provided at the top side of the container 200; upon end of spraying, the pressure relief valve 700 is operable to open the pressure relief hole 210 to release air pressure in the container 200, preventing the paint in the container 200 from still flowing toward the liquid outlet hole 311 and leaking out therefrom upon end of the spraying. Exemplarily, the pressure relief valve 700 comprises a plug head 710, a valve bonnet 720, and a third spring 730, the plug head 710 being formed with an increasing outer diameter from top to bottom, an outer diameter of a lower end of the plug head 710 being greater than an aperture of the pressure relief hole 210, the lower end of the plug head 710 being disposed inside the container 200, an outer diameter of an upper end of the plug head 710 being smaller than the aperture of the pressure relief hole 210, the upper end of the plug head 710 projecting upward out of the container 200 from the pressure relief hole 210; the valve bonnet 720 is disposed outside the container 200 and secured with the upper end of the plug head 710 via a fastener. The third spring 730 is sleeved outside the plug head 710 and is disposed in a compressed state, a lower end of the third spring 730 abutting against the container 200 so as to be positioned, an upper end thereof abutting against the valve bonnet 720. To enhance the effect of the pressure relief valve 700 closing the pressure relief hole 210, a seal ring 740 is sleeved on the plug head 710, the seal ring 740 abutting against a step of the plug head 710 and being disposed inside the container 200. The third spring 730 applies an upward pretensioned force against the plug head 710 via the valve bonnet 720 so that the plug head 710 normally closes the pressure relief hole 210. To release air pressure in the container 200, the valve bonnet 720 is pressed down so that the valve bonnet 720 is stressed to drive the plug head 710 to move downward to compress the third spring 730, whereby the downward moving plug head 710 opens the pressure relief hole 210 and the air in the container 200 may be discharged through the pressure relief hole 210 out of the container 200. Upon end of pressure relief, the valve bonnet 720 is loosened, and the third spring 730 recovered from deformation drives, via the valve bonnet 720, the plug head 710 to move upward and reset till a state of closing the pressure relief hole 210.

Referring to FIG. 12, a threaded-fit structure is arranged between the container 200 and the connecting portion 133 of the gun body 100, the container 200 being detachably connected to the gun body 100 via the threaded-fit structure. To allow for the paint in the container 200 to flow towards the valve chamber 135 only from the liquid intake tube 140, a sealing pad 160 is arranged between the top end of the container 200 and the connecting portion 133, the sealing pad 160 being sleeved at an upper end of the liquid intake tube 140 so as to be axially positioned. When the container 200 is fitted with the connecting portion 133, the sealing pad 160 is tightly held between the top end of the container 200 and the connecting portion 133.

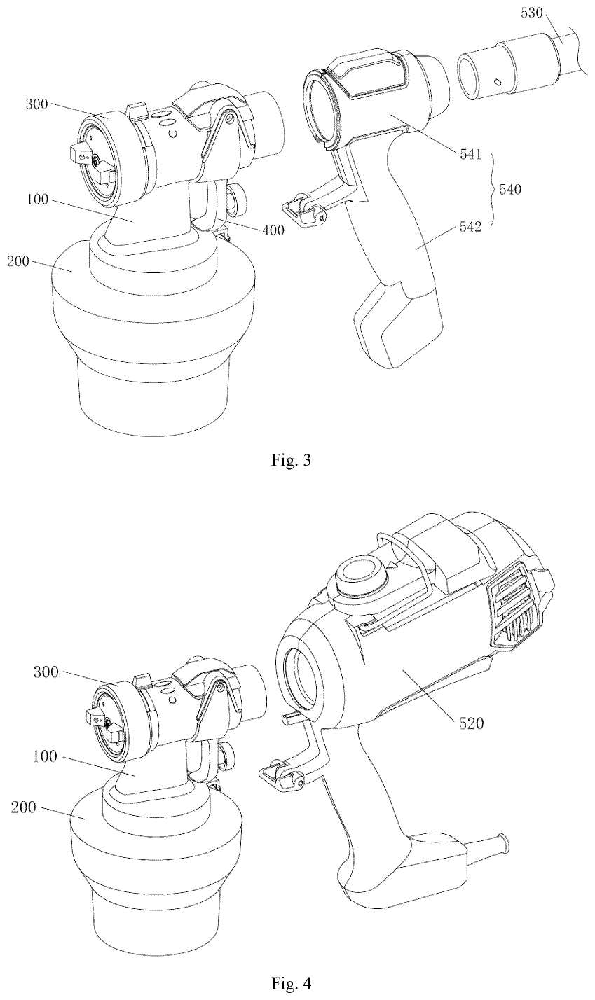

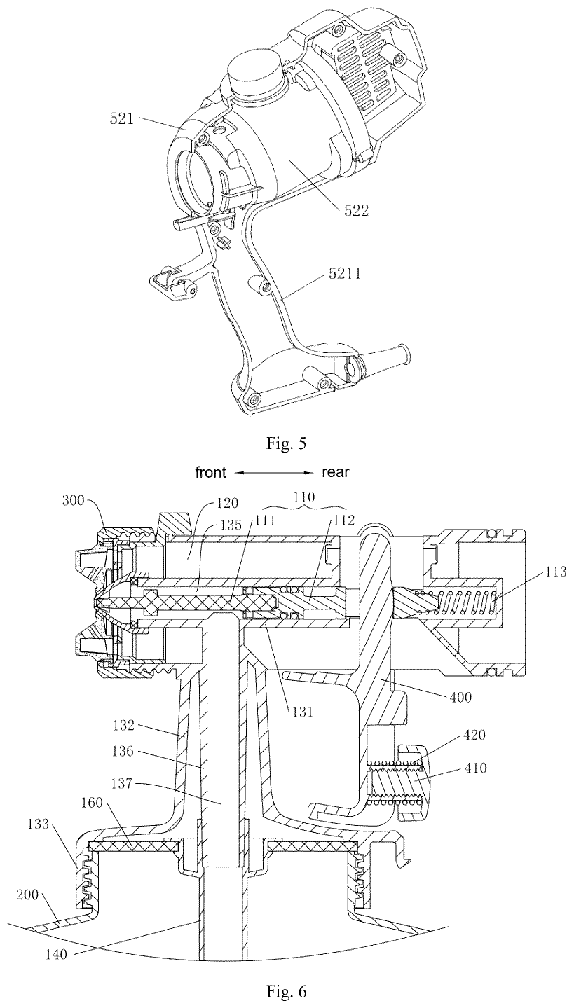

Referring to FIGS. 1 and 4, in this implementation, the pneumatic sprayer further comprises a stationary body 510 and a handheld body 520, the gun body 100 being attachable to the stationary body 510 or the handheld body 520. Referring to FIGS. 2 and 3, the stationary body 510 comprises a first housing 511 and a first air compressor 512 disposed in the first housing 511, the stationary body 510 being attached with a handle piece 540 via an air tube 530, the handle piece 540 being detachably connected to a rear end of the gun body 100. The handle piece 540 comprises a cylindrical shell 541 fitted with the barrel portion 131 and a handle 542 configured to be held by a user; a locking-fit structure configured to tightly lock the handle piece 540 and the gun body 100 is arranged therebetween. One end of the air tube 530 is detachably connected to the stationary body 510 via an adaptor, and an opposite end of the air tube 530 is detachably connected to the handle piece 540 via an adaptor; the container 200 may be disposed on the stationary body 510. Referring to FIG. 5, the handheld body 520 comprises a second housing 521 and a second air compressor 522 disposed in the second housing 521, the second housing 521 being formed with a grip 5211, a locking-fit structure configured to lock the second housing 521 and the gun body 100 being arranged therebetween. The stationary body 510 is preferably powered by a battery pack, and the handheld body 520 is preferably powered by an external power source connected via a wire; the gun body 100 may be assembled with the stationary body 510 or the handheld body 520 into a complete set dependent on spray applications. The pressurized air produced when the first air compressor 512 or the second air compressor 522 is operating may flow into the air passage 120 of the barrel portion 131. It may be understood that, the locking-fit structure may adopt a multi-point lock fitting manner to ensure lock-fitting stability; and the locking-fit structure may adopt an existing rotary snap-rotary recess fitting structure and/or a shackle-snap block fitting structure, or the like.

In operation, the gun body 100 is attached to the stationary body 510 or the handheld body 520; the pressurized air produced by the operating air compressor flows into the air passage 120; part of the air flowing into the air passage 120 flows through the ventilation structure 600 into the container 200 so that under the action of the pressurized air, the paint in the container 200 flows upward through the liquid intake tube 140 and the guiding tube 136 into the valve chamber 135, and another part of the air flows forward towards the air outlet holes 325 through the adjustment holes 342 and the communication holes 316 and is finally sprayed out from the three air outlet holes 325. The trigger 400 is forced to swing rearward; the rearward swinging trigger 400 drives the valve core 110 to overcome the pretensioned force of the first spring 113 to move rearward to open the liquid outlet hole 311; under the action of the air pressure, the paint in the valve chamber 135 is sprayed forward out via the liquid outlet hole 311; the pressurized air sprayed out of the air outlet holes 325 acts on the paint sprayed out of the liquid outlet hole 311 so that the paint is atomized; the atomized paint is adhered onto a to-be-applied object to thereby realize spraying.

To adjust a spray effect, the adjustment cap 340 may be rotated via the shifting block 341 to adjust the ventilation area between the air passage 120 and the communication hole 316, which then realizes adjustment of the intensity of the air flow sprayed out from the air outlet holes 325, and finally, an atomization effect of the paint sprayed out from the liquid outlet holes 311 is adjusted.

To adjust the flow rate of paint spray, an amplitude of rearward swinging of the trigger 400 may be adjusted via the rotary knob 410, which then realizes adjustment of the open degree of the liquid outlet hole 311 opened by the core shaft 111, whereby the flow rate of the paint sprayed out of the liquid outlet hole 311 is adjusted.

It may be understood that setting of the adjustment cap 340 may be alternatively cancelled.

It may be understood that setting of the pressure relief valve 700 may also be cancelled from the container 200.

It may be understood that a specific structure of the unidirectional air intake valve 620 may not be limited to the description above or the drawings, and an alternative unidirectional valve structure satisfying ventilation requirements may also be adopted.

It may be understood that the ventilation structure 600 may also adopt an alternative reasonable structure.

It may be understood that, the stationary body 510 and the handheld body 520 may also be alternatively provided, i.e., the pneumatic sprayer is only equipped with the stationary body 510 or only equipped with the handheld body 520.

In addition to the preferable implementations described supra, the present disclosure also has other implementations. All of such other implementations derived by those skilled in the art on the basis of those described herein without exercise of inventive work shall all fall within the scope of protection of the disclosure.

1. A pneumatic sprayer, comprising: a gun body comprising a valve core and an air passage, a container attached to the gun body, a nozzle assembly disposed at a front end of the gun body, and a trigger acting on the valve core, the nozzle assembly comprising a nozzle cap provided with a liquid outlet hole, an air cap disposed at a front side of the nozzle cap, and a lock ring securing the nozzle cap and the air cap to the front end of the gun body, the air cap being provided with an air outlet hole communicating with the air passage, wherein a snap-fit structure is arranged between the nozzle cap and the air cap, and the lock ring locks the nozzle cap and the air cap which have been snapped together to the front end of the gun body.

2. The pneumatic sprayer of claim 1, wherein an annular protrusion extending axially is arranged at an outer peripheral edge of the air cap, and a front raised edge is provided for the nozzle cap, the front raised edge extending forwardly from an outer peripheral edge of the nozzle cap, the snap-fit structure being disposed between the annular protrusion and the front raised edge.

3. The pneumatic sprayer of claim 2, wherein the snap-fit structure comprises a first snap-fit part arranged on an outer wall of the annular protrusion and a second snap-fit part arranged on an inner wall of the front raised edge, the second snap-fit part and the first snap-fit part being snapped in a front-rear direction so that the air cap and the nozzle cap are limited relative to each other.

4. The pneumatic sprayer of claim 3, wherein the first snap-fit part is a convex rib or a protrusion; and/or, the second snap-fit part is a convex rib or a protrusion.

5. The pneumatic sprayer of claim 2, wherein a limiting rib protruding forward is arranged at a front side of the front raised edge and/or at a front side of the gun body, and a limiting block is arranged on an outer wall of the annular protrusion, the limiting block abutting against an end portion of the limiting rib so that the air cap is circumferentially limited.

6. The pneumatic sprayer of claim 1, wherein the nozzle cap is provided with a communication hole configured to communicate between the air passage and the air outlet hole, and the nozzle assembly further comprises an adjustment cap disposed between the front end of the gun body and the nozzle cap, the adjustment cap being provided with a shifting block projecting out of the gun body and an adjustment hole corresponding to the communication hole, the adjustment cap being rotated to adjust a ventilation area between the air passage and the communication hole.

7. The pneumatic sprayer of claim 6, wherein a slide groove in which the shifting block moves and a groove opening communicating with the slide groove are provided at the front end of the gun body, the slide groove extending along a circumferential direction of the gun body, the groove opening extending forward from one end of the slide groove, the nozzle cap being provided with a limiting tab that extends rearward and fits the groove opening; and/or, the nozzle cap is provided with a rear raised edge extending rearward from an outer peripheral edge of the nozzle cap, a stepped surface being provided on an outer peripheral wall of the adjustment cap, the rear raised edge abutting against the stepped surface.

8. The pneumatic sprayer of claim 1, wherein the lock ring is tightly locked to the front end of the gun body in a threaded-fitting manner, a circle of limiting edge protruding inwardly and fitted with an outer peripheral edge of the air cap is provided at a front end of the lock ring, and a stud abutting against a front side of the limiting edge is arranged on an outer wall of the air cap.

9. The pneumatic sprayer of claim 1, wherein a ventilation structure configured to communicate between the air passage and an internal cavity of the container is arranged between the gun body and the container; and/or, a pressure relief hole and a pressure relief valve operable to open and close the pressure relief hole are provided on the container.

10. The pneumatic sprayer of claim 1, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

11. The pneumatic sprayer of claim 2, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

12. The pneumatic sprayer of claim 3, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

13. The pneumatic sprayer of claim 4, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

14. The pneumatic sprayer of claim 5, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

15. The pneumatic sprayer of claim 6, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

16. The pneumatic sprayer of claim 7, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

17. The pneumatic sprayer of claim 8, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.

18. The pneumatic sprayer of claim 9, wherein the pneumatic sprayer further comprises a stationary body inside which a first air compressor is provided, the stationary body being attached with a handle piece via an air tube, the handle piece being detachably connected to the gun body; and/or, the pneumatic sprayer further comprises a handheld body inside which a second air compressor is provided, the handheld body being detachably connected to the gun body.
